(19) United States
(12) Patent Application Publication
(10) Pub. No.: US 2026/0258922 A1
(43) Pub. Date: Sep. 3, 2026

(54) LIGHT UNIT FOR A MOTOR VEHICLE

(71) Applicant: VALEO VISION, Bobigny (FR)

(72) Inventor: Yves GROMFELD, Bobigny (FR)

(73) Assignee: VALEO VISION, Bobigny (FR)

(21) Appl. No.: 19/491,252

(22) PCT Filed: Jun. 7, 2024
(86) PCT No.: PCT/EP2024/065805

§ 371 Date: Dec. 8, 2025

(30) Foreign Application Priority Data
Jun. 8, 2023 (FR) FR2305775

(51) Int. Cl. F21S 41/147; F21S 41/25

(52) U.S. Cl. CPC F21S 41/147; F21S 41/25

(57) ABSTRACT

A light unit for a motor vehicle, including a row of light sources emitting light rays, a support on which the row of light sources is arranged, a primary lens having an optical axis and a first input face, and a projecting lens. The row of light sources includes light sources that can be activated individually and are aligned in a first direction. The support forms an angle α other than 90° with the optical axis. The first input face includes a planar upper portion, a planar lower portion and a connecting portion. The lower portion is offset relative to the upper portion about the optical axis. The upper portion and the lower portion are connected.

### TECHNICAL FIELD

The present invention relates to the field of lighting, this including signaling, and to the field of members, notably optical members, that participate therein. It is particularly advantageously applicable to the field of automotive vehicles. In particular, it relates to a luminous unit for an automotive vehicle, and to a luminous module for an automotive vehicle, comprising a plurality of luminous units.

### BACKGROUND OF THE INVENTION

In the automotive sector, modules capable of emitting light beams, also referred to as lighting and/or signaling functions, are known.

These modules have to meet the applicable regulations, and also have to afford sufficient safety and sufficient comfort, by emitting light specifically in certain zones and excluding other zones that should remain dark, while ensuring homogeneous lighting. In particular, when a zone has to be lit, it is necessary to prevent it from comprising dark regions within it.

Manufacturers also face constraints related to the reduction of the size of the module and to the shape of the module, notably requiring inclination of the support, consisting of an electronic circuit for holding and electrically connecting a set of electronic components (PCB, standing for Printed Circuit Board), carrying the light sources, in order to allow satisfactory integration, notably in terms of design, into the vehicle.

In order to best achieve these different objectives, a technical solution has been proposed based on the positioning of an inclined support for light sources and on a modification of the curvature of certain parts of the exit face of the primary lens and of the entrance face of the projection lens, so as to obtain a greater distribution of the brightness in desired zones.

Nevertheless, this type of solution has drawbacks and notably the fact that it does not allow an inclination with respect to the vertical of the support for the light sources while making it possible to obtain a homogeneous light beam, and therefore a minimal bulk and a desired arrangement while allowing satisfactory generation of light beams, for example in terms of imaging quality.

An object of the present invention is therefore to propose a module that makes it possible to overcome all or some the cited drawbacks.

The other objects, features and advantages of the present invention will become apparent upon studying the following description and the accompanying drawings. It will be understood that other advantages may be incorporated.

### SUMMARY OF THE INVENTION

To achieve this objective, according to one embodiment, a luminous unit for an automotive vehicle is provided, the unit comprising:
a row of light sources emitting light rays, the row of light sources comprising light sources aligned in a first direction, the light sources of the row of light sources being individually activatable,
a support on which the row of light sources is disposed, and
an optical system comprising:
a primary lens comprising an optical axis, a first entrance face and an exit face, and
a projection lens, the light rays passing first through the primary lens and second through the projection lens,
wherein a plane is perpendicular to the first direction and comprises the optical axis, and

The luminous unit is noteworthy in that the support forms with the optical axis an angle different from 90°, and in that the first entrance face comprises a planar upper portion, a planar lower portion and a connecting portion, the lower portion being offset relative to the upper portion along the optical axis, the upper portion and the lower portion being connected by the connecting portion.

It will be noted that the first entrance face is an entrance face for light rays emitted by the row of light sources.

In addition, the exit face is an exit face for light rays received by the first entrance face.

Thus, the luminous unit according to the invention, due to the positioning of a support inclined with respect to the optical axis, makes it possible to obtain a configuration that meets the arrangement and bulk constraints. Moreover, given that this inclination of the support for the row of light sources is associated with a particular shape of the entrance face of the primary lens, the luminous unit according to the invention makes it possible to obtain lighting having sufficient homogeneity (and notably not having a clear delimitation (in the zone to be lit) between lit zones and less lit zones, contrary to the luminous projection shown in FIG. 3 which indicates, by the dashed box, the positioning of the zone representing a clear delimitation).

More specifically, the fact that the entrance face of the primary lens has an inclined connecting portion (with respect to the upper portion and with respect to the lower portion) creates (at the connecting portion) a local zone of deflection of the light rays having the result of creating a blurring in the projection of the light rays in question (the blurring being at the junction between the lit zones and the less lit zones). The positioning of an inclined connecting portion therefore compensates for the effect associated with the inclination of the support.

Specifically, the inclination of the support leads to a difference (in the resulting lighting) between the light rays being directed toward the top and those directed toward the bottom of the entrance face of the primary lens, this difference being due to the fact: 1) that the light rays being directed toward the top are greater than those directed toward the bottom of the entrance face of the primary lens, and 2) that the part of the light sources from which the light rays moving toward the bottom (of the entrance face of the primary lens) emerge is not positioned at the same distance from the main object focal point of the optical system comprising the primary lens and the projection lens as the part of the light sources from which the light rays moving toward the top (of the entrance face of the primary lens) emerge. The difference in question is manifested (on the projection zone) by a clear delimitation (in the zone to be lit) between the lit zones and the less lit zones (the lit zones being the result of the light rays being directed toward the top of the primary lens while the less lit zones are the result of the light rays being directed toward the bottom of the primary lens).

According to another aspect, the invention relates to a luminous module for an automotive vehicle, comprising a plurality of luminous units, the luminous units being superposed in a second direction, the luminous units sharing the same support, the second direction being perpendicular to the optical axis and to the first direction.

Thus, the luminous module according to the invention makes it possible to obtain lighting characterized by a greater luminous intensity (or luminance) and also by more extended lighting (notably in height) than if the luminous module were made up of a single luminous unit.

Another aspect is a vehicle equipped with at least one unit and/or module, preferably for emission of light toward the front of the vehicle. At least one module can equip a right-hand side of the front face of the vehicle and at least one module can equip a left-hand side of the front face of the vehicle.

### BRIEF DESCRIPTION OF THE DRAWINGS

The aims, objects, features and advantages of the invention will become more clearly apparent from the detailed description of one embodiment thereof, which is illustrated by the following accompanying drawings, in which:

FIG. 1 shows a sectional view of the luminous unit according to the invention, in which the entrance face of the primary lens can be seen.

FIG. 2 shows a sectional view of the luminous module according to the invention, in which the mutual arrangement of the luminous units can be seen.

FIG. 3 schematically shows the projection at the front of a vehicle of a complementary high beam in the case where the entrance face of the primary lens is planar and where the support is inclined with respect to the optical axis so that the light rays are oriented more toward the top of the entrance face of the primary lens than toward the bottom of the entrance face of the primary lens. FIG. 3 indicates, by virtue of the dashed box, the positioning of the clear delimitation zone.

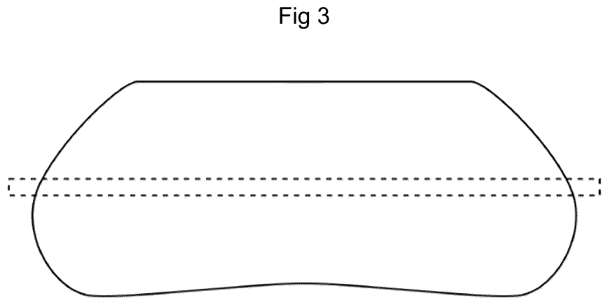

The drawings are provided by way of example and do not limit the invention. They are schematic conceptual representations intended to facilitate understanding of the invention and are not necessarily drawn to the scale of practical applications. In particular, the orientation of the light rays is schematic and is not representative of reality.

### DETAILED DESCRIPTION OF THE INVENTION

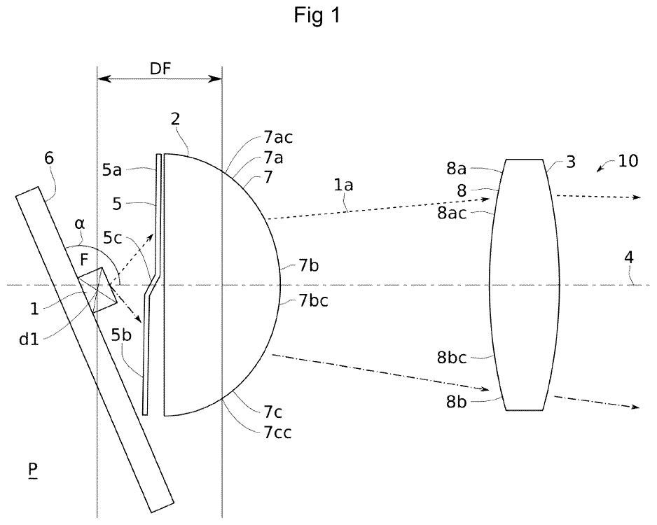

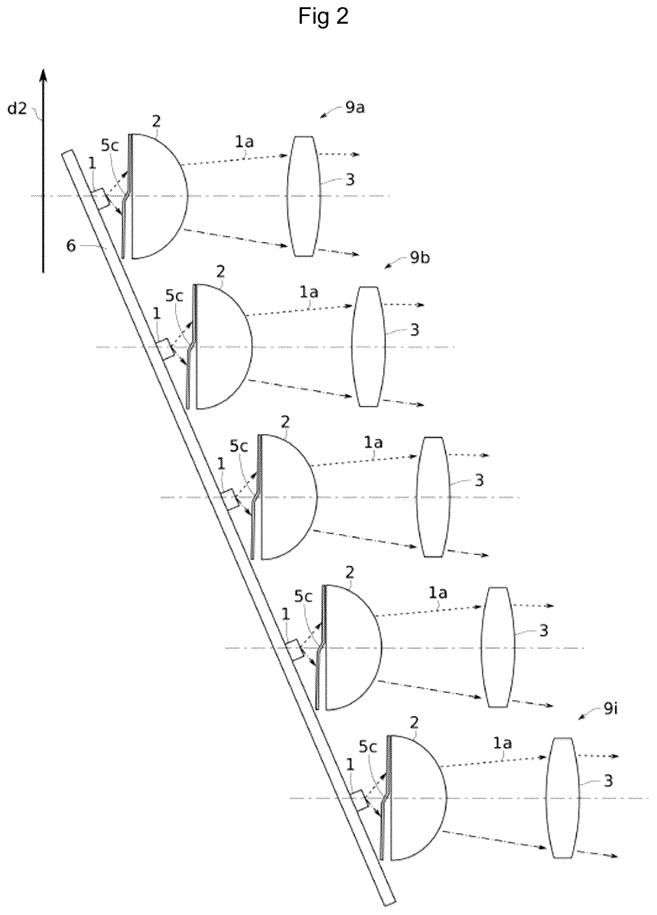

Before starting a detailed review of embodiments of the invention as shown in FIG. 1 and FIG. 2, optional features that may optionally be used in combination or alternatively will be described below:

According to one example, the first entrance face 5 receives the light rays 1a emitted by the row 1 of light sources. In other words, the planar upper portion 5a, the planar lower portion 5b and the connecting portion 5c receive the light rays 1a emitted by the row 1 of light sources.

According to one example, the upper portion 5a is offset along the optical axis 4, relative to the lower portion 5b, in order to be closer to the exit face 7.

According to one example, the upper portion 5a is offset along the optical axis 4, relative to the lower portion 5b, in order to be farther away from the exit face 7.

Given that the objective of positioning a connecting portion inclined with respect to the upper portion and with respect to the lower portion is to create a blurring in the projection of the light rays that have traversed this connecting portion, irrespective of the positioning of the upper portion with respect to the lower portion, the desired technical effect will be obtained. Thus, the upper portion can be positioned upstream (or downstream) of the lower portion along the optical axis.

According to one example, the support 6 is inclined with respect to the optical axis 4 so that the light rays 1a are oriented more toward the upper portion 5a than toward the lower portion 5b.

This configuration makes it possible to obtain a significant degree of lighting (after the projection lens) oriented toward the zone above the road, in order to obtain good visibility at this location.

According to one example, the optical system 10 has a main object focal point F, the light sources of the row 1 of light sources being positioned with respect to the optical axis 4 so that, in the plane p, their orthogonal projection on the optical axis 4 intercepts the optical axis 4 at the main object focal point F.

Thus, given that the row 1 of light sources is positioned at the main object focal point F, the image of the light rays (coming from the row 1 of light sources) by the optical system 10 will be at infinity. This configuration will thus make it possible to obtain a light beam resulting from this row of light sources that is projected over a long distance. Thus, the light beam coming from this row could be a complementary high beam.

According to one example, the row 1 of light sources is traversed by the optical axis 4.

According to one example, the angle α is greater than 90° and lower than or equal to 120°, and the connecting portion 5c is traversed by the optical axis 4.

Specifically, when the support 6 forms with the optical axis 4 an angle α greater than 90° and lower than or equal to 120°, the light rays coming from the upper part of the emissive area of each light source of the row 1 and therefore the light rays which are directed toward the top of the entrance face of the primary lens will reach the entrance face of the primary lens in such a way that the lowest part reached is reached approximately at the optical axis 4. It is thus necessary for the connecting portion 5c to be positioned at the optical axis 4 in order to be able to create a blurring at the junction between the lighting coming from the rays being directed toward the top of the entrance face of the primary lens and those being directed toward the bottom of the entrance face of the primary lens. It is considered that the emissive area of each light source of the row 1 is separated into two identical parts, one part called the “upper part” which is located above the other part called the “lower part”.

According to one example, the angle α is greater than 120° and lower than or equal to 135°, and the connecting portion 5c is offset with respect to the optical axis 4 so as to reduce the size of the upper portion 5a.

Thus, when the support 6 forms with the optical axis 4 an angle α greater than 120° and lower than or equal to 135°, the light rays coming from the upper part of the emissive area of each light source of the row 1 and therefore the light rays which are directed toward the top of the entrance face of the primary lens 2 will reach, at the lowest part, a zone of the entrance face of the primary lens positioned above the optical axis 4. It is thus necessary for the connecting portion 5c to be positioned approximately at the lowest zone of the entrance face of the primary lens where the rays directed toward the top of the primary lens will be directed in order to be able to create a blurring at the junction between the lighting coming from the rays being directed toward the top of the entrance face of the primary lens and those being directed toward the bottom of the entrance face of the primary lens.

According to one example, the optical system 10 has a focal length DF, the length of the orthogonal projection in the plane p on the optical axis 4 of the connecting portion 5c being proportional to the focal length DF by applying a proportionality factor comprised between 0.02 and 0.03, the proportionality factor is preferably equal to 0.025.

Thus, by virtue of this configuration, the more the focal length of the optical system increases, the more the component of the connecting portion 5c along the optical axis also increases. Indeed, this configuration is necessary because the greater the focal length of the optical system comprising the primary lens and the projection lens, (for a row of light sources positioned at the main object focal point of the optical system comprising the primary lens and the projection lens) the more the light rays coming from the row of light sources will diverge (at the entrance face of the primary lens) and therefore, without an adjustment of the value of the component of the connecting portion 5c along the optical axis 4, the more the relative position of the different parts of the light sources of the row 1 of light sources with respect to the main object focal point F will influence the resulting projection of the light rays and therefore the presence of a clear delimitation (or contrast line) (in the zone to be lit) between the lit zones and the less lit zones.

According to one example, the upper portion 5a and the lower portion 5b are perpendicular to the optical axis 4.

According to one example, the first entrance face 5 has, in the plane p, a profile describing a sigmoid function.

According to one example, the exit face 7 comprises a first upper part 7a having a first curvature 7ac along the plane p, a central part 7b having a fifth curvature 7bc along the plane p and a first lower part 7 c having a second curvature 7cc along the plane p, and wherein the projection lens 3 comprises a second entrance face 8 comprising a second upper part 8a having a third curvature 8ac along the plane p and a second lower part 8b having a fourth curvature 8bc along the plane p, the first curvature 7ac being more convex than the fifth curvature 7bc and/or the second curvature 7cc being more convex than the fifth curvature 7 bc and/or the fourth curvature 8bc being more convex than the third curvature 8ac.

Thus, these configurations make it possible to obtain a greater spread, along the planes perpendicular to the first direction d1 and parallel to the optical axis 4 (therefore in the vertical direction), for the light rays being passed respectively through the first upper part 7a, the first lower part 7c, and the second lower part 8b in comparison respectively with those passed through the central part 7b and the second upper part 8a. These configurations thus make it possible to obtain lighting having the desired extent. The curvature of the first upper part 7a also makes it possible, in the case of the integration into the luminous unit producing a low-beam near-field beam, to obtain a better recombination between the complementary high beam and the low-beam near-field beam.

According to one example, the luminous unit is configured to form or to participate in forming a segmented complementary high beam.

According to one example, the light sources of the row 1 of light sources of each of the luminous units 9a, 9b, . . . , 9i are offset, in the first direction d1, relative to the light sources of the rows 1 of light sources of all the other luminous units 9a, 9b, . . . , 9i.

This configuration therefore makes it possible to create a lateral offset (in the first direction d1) between the segments formed by a luminous unit with respect to the segments formed by the other luminous units forming the luminous module. The fact that the light sources of all rows 1 of light sources are offset relative to one another makes it possible to eliminate dark zones that may appear between the projections of the segments resulting from the switching on of a group of light sources from the row of light sources, this having the consequence of increasing the spatial resolution because the final size of the segments can thus be smaller.

With respect to the features set out in the present description, terms relating to verticality, horizontality or transversality (or even the lateral direction), or equivalents thereof, are to be understood with respect to the position in which the luminous module is intended to be fitted in a vehicle. The terms “vertical” and “horizontal” are used in the present description to denote, regarding the term “vertical”, a direction with an orientation perpendicular to the plane of the horizon (which corresponds to the height of the modules), and, regarding the term “horizontal”, a direction with an orientation parallel to the plane of the horizon. They are to be considered under the conditions of operation of the module in a vehicle. Thus, a vertical axis is directed in the same direction as the field of Earth's gravity and a horizontal axis is directed in a direction perpendicular to the direction of the field of Earth's gravity. The use of these words does not mean that slight variations about the vertical and horizontal directions are excluded from the invention. For example, an inclination relative to these directions of the order of + or −10° is here considered to be a minor variation about the two preferred directions. With respect to the horizontal plane, the inclination is in principle between −5° and +4°, and is between −6° and +7.5° laterally.

In the context of the present description, the adjectives “lower” and “upper”, and equivalents thereof (under, below, over, above), are to be considered in relation to the vertical direction, that is to say the direction perpendicular to the first direction d1 and to the optical axis 4. In a given context, an upper element is located above (but not necessarily in contact, or directly plumb with) a lower element, in the vertical direction.

An “upper part (or portion)” is understood to mean a zone located higher up, compared with a “lower part (or portion)”. In this configuration, a “central part (or portion)” is understood to mean the part located between the “upper part (or portion)” and the “lower part (or portion)”.

The term “traverse” in the context of an element being traversed by an axis is understood to mean the fact that the axis passes through the element in question.

In the context of the present invention, the term “planar” in the context of “the upper portion 5a and the lower portion 5b are planar” takes account of the fact that the upper portion 5a and/or the lower portion 5b may have at their surface a variability in their planarity which may reach a value up to 100 μm. This variability in planarity is not uniform over the entire surface in question and may correspond to asperities forming reliefs on the surface in question and/or to hollow zones on the surface in question. This variability in planarity is measured with respect to a reference plane. The reference plane for the upper portion 5a and for the lower portion 5b respectively correspond to the plane forming the upper portion 5a and to the plane forming the lower portion 5b respectively if these portions were planar. Thus, the upper portion 5a and/or the lower portion 5b can be characterized as being “pseudo-planar”.

According to a preferred embodiment, the luminous unit for an automotive vehicle comprises a row 1 of light sources, a primary lens 2, a projection lens 3 and a support 6. The row 1 of light sources emits light rays 1a . The row 1 of light sources comprises light sources arranged on a straight line in a first direction d1. The light sources of the row 1 of light sources are able to be selected individually in order to be switched on. The primary lens 2 has an optical axis 4. The primary lens 2 comprises a first entrance face 5 and an exit face 7. The first entrance face 5 is an entrance face for light rays 1a emitted by the row 1 of light sources. The light rays 1a are transmitted first through the primary lens 2 and second through the projection lens 3. The row 1 of light sources is secured to the support 6. A plane p is defined so as to be perpendicular to the first direction d1 and to comprise the optical axis 4. The optical system 10 comprises the primary lens 2 and the projection lens 3.

The support 6 is inclined with respect to the optical axis 4 and therefore forms with the optical axis 4 an angle α different from a right angle. The support 6 is therefore not perpendicular to the optical axis 4. The first entrance face 5 comprises a planar upper portion 5a, a planar lower portion 5b and a connecting portion 5c. The upper portion 5a and the lower portion 5b are joined by the connecting portion 5c. The first entrance face 5, and more particularly each of the planar upper portion 5a, planar lower portion 5b and connecting portion 5c, receives the light rays 1a emitted by the row 1 of light sources.

The lower portion 5b and the upper portion 5a are not in the same position along the optical axis 4. If the optical axis 4 is considered to be a graduated axis, the abscissa of the lower portion 5b is different from the abscissa of the upper portion 5a. An angled junction zone therefore appears on the entrance face of the primary lens at the connecting portion 5c.

The light beam formed from the light rays coming from the row 1 of light sources is projected along the optical axis 4.

The face of the support 6 carrying the sources may be planar. The light sources are positioned on this face of the support 6, which may be directed, in the use position, toward the top of the luminous unit. The support 6 may form with the optical axis 4 an angle α having a value of 100°. Preferably, the light sources have a mean emission direction oriented along a normal to the face of the support 6 which carries them.

The connecting portion 5c may be planar, concave or convex. The connecting portion 5c may have a planar part and a convex part or a planar part and a concave part or a convex part and a concave part. The connecting portion 5c may have a planar part, followed by a convex part, itself followed by a concave part.

The row 1 of light sources may comprise 5 light sources.

The exit dioptric interface of the projection lens may be convex. The radius of curvature of the exit dioptric interface of the projection lens may be large so that the exit dioptric interface of the projection lens can be likened to a plane.

The luminous unit may have a width of 20 mm (in the first direction d1). The length of the row 1 of light sources may be 5 mm (in the first direction d1). The focal length of the optical system made up of the primary lens and of the projection lens may be 10 mm.

The thickness of the primary lens may be 6.5 mm. The thickness of the projection lens may be 6 mm. The diameter of the projection lens may be 20 mm.

The row 1 of light sources only comprises light sources that are all aligned in the direction d.

The row 1 of light sources may be positioned at a distance comprised between 0.25 mm and 5 mm from the entrance face of the primary lens. Preferably, the row 1 of light sources may be positioned at a distance of 1.3 mm from the entrance face of the primary lens.

The light sources of the row 1 of light sources may be activated in groups so that only certain light sources of the row 1 of light sources are activated at a given time.

The primary lens makes it possible to shape the light rays coming from the row of light sources into a beam of light. The projection lens allows the projection of the light rays shaped by the primary lens.

At least one of the entrance face of the projection lens and the exit face of the projection lens may have notably micron-sized reliefs on its surface. “Notably micron-sized reliefs” are understood to mean a surface finish, especially on a dioptric interface, comprising a set of protruding elements having notably a depth of less than 600 μm. More specifically, this microstructure may protrude over a depth notably of less than 50 μm in the case of the exit face, and over a depth notably of less than 600 μm in the case of the entrance face. This microstructure may comprise concentric patterns. The patterns may be stripes or dimples. The positioning of these reliefs allows the beam to be made uniform.

The support 6 may be in the form of a printed circuit board (PCB).

The light sources of the row 1 of light sources can be switched on selectively, thereby creating a pixelated light source.

This configuration makes it possible to produce adaptive driving beam (ADB) lighting. Specifically, selective activation of the light sources makes it possible to obtain varied light beam configurations making it possible to adapt to various situations. Thus, zones that should be lit will be and zones in which brightness should be decreased to avoid dazzling other road users and to meet regulatory constraints will also be.

This discretization of the light is also referred to as a segmented beam. Thus, a beam the projection of which forms an image made up of beam segments (generated by switching on a group of light sources), each segment being able to be lit independently, is referred to as a segmented beam.

Thus, all the emissive elements are not necessarily active, i.e. emit light, simultaneously. This function allows the shape of the generated beam to be modulated. If a light source is not activated, its image will not be projected by the optical module. It then forms a dark zone in the resulting overall beam. Excluding the effects of coupling in the source and the effects of stray light from the optics, the void thus created is complete.

More specifically, ADB lighting improves night driving conditions by allowing the driver to light the road on which they are traveling as much as possible without dazzling other users. For this purpose, the resulting beam is formed by a plurality of juxtaposed segments that are selectively and individually activatable. Thus, if a user is detected by the module, only the segment liable to dazzle the user is switched off (the other segments remaining switched on), thereby allowing lighting of the road to be optimized.

The module according to the invention may comprise a unit for driving the activation of each of the sources that is configured to produce at least one dark zone forming a tunnel in a projected beam by deactivating a group of adjacent sources, the driving unit being configured to determine the number of sources of the group corresponding to the dark zone depending on the widthwise dimension of the sources.

The driving unit may comprise a computer program product, preferably stored in a non-transient memory, the computer program product comprising instructions that, when executed by a processor, determine the sources to be activated, in particular to obtain at least one dark zone (in which the sources are not activated) of defined area, taking into account the variable area of the images of the elements.

The light sources of the overall device may be light-emitting diodes, also commonly called LEDs.

Advantageously, the LEDs of the overall lighting module have an emissive area of 0.5 mm² or of 1 mm² . LEDs having an emissive area of 0.5 mm² may have a height and a width of 0.76 mm. LEDs having an emissive area of 1 mm² may have a height and a width of 1 mm. The size of the LEDs is directly related to the desired beam volume.

The distance between the centers of two consecutive LEDs of the row 1 of light sources may be 1.025 mm. The spacing between two consecutive LEDs may be 25 μm.

Preferably, the primary lens and the projection lens are made of PMMA (polymethyl methacrylate), silicone, glass or PC (polycarbonate).

According to a preferred example, the lower portion 5b may be upstream with respect to the upper portion 5a along the optical axis 4. Advantageously, the lower portion 5b may be downstream with respect to the upper portion 5a along the optical axis 4.

In the case where the upper portion 5a is positioned upstream with respect to the lower portion 5b (along the optical axis 4), the performance is better than in the case where the lower portion 5b is positioned upstream with respect to the upper portion 5a (along the optical axis 4).

The center of the exit face of the primary lens, through which the optical axis 4 passes, is the reference point for the positional offset between the lower portion 5b and the upper portion 5a along the optical axis 4. Thus, in a case where the upper portion 5a is positioned upstream with respect to the lower portion 5b (along the optical axis 4), the orthogonal projection of the upper portion 5a on the optical axis 4 is closer to this center than that of the lower portion 5b. Thus, in a case where the upper portion 5a is positioned downstream with respect to the lower portion 5b (along the optical axis 4), the orthogonal projection of the upper portion 5a on the optical axis 4 is farther away from this center than that of the lower portion 5b.

Preferably, the support 6 forms with the optical axis 4 an angle α so that the light rays 1a are directed more toward the upper portion 5a than toward the lower portion 5b.

According to an advantageous example, the optical system 10 has a main object focal point F. Preferably, the light sources of the row 1 of light sources are positioned with respect to the optical axis 4 so that, in the plane p, their orthogonal projection on the optical axis 4 intercepts the optical axis 4 at the main object focal point F. More specifically, it is the center of the light sources that is positioned at the main object focal point F along the optical axis 4, in the plane p.

According to one possibility, the row 1 of light sources is in contact with the optical axis 4. The row 1 of light sources may be traversed by the optical axis 4 at the center of the light source positioned at the center of the row 1 of light sources.

According to a preferred example, when the support 6 forms with the optical axis 4 an angle α strictly greater than 90° (i.e. the value of 90° is excluded) and lower than or equal to 120°, the connecting portion 5c is in contact with the optical axis 4.

Preferably, when the support 6 forms with the optical axis 4 an angle α strictly greater than 120° (i.e. the value of 120° is excluded) and lower than or equal to 135°, the connecting portion 5c is eccentric with respect to the optical axis 4 so as to be positioned more toward the top of the luminous unit.

The connecting portion 5c may be offset with respect to the optical axis so as to be positioned at the highest level at the limit between the first quarter and the second quarter of the first entrance face 5 (the first quarter corresponding to the highest quarter of the first entrance face 5 and the second quarter corresponding to the second highest quarter of the first entrance face 5).

Advantageously, the optical system 10 has a focal length DF. Preferably, the length of the orthogonal projection in the plane p on the optical axis 4 of the connecting portion 5c may be deduced from the focal length DF by applying a proportionality factor (to the length of the orthogonal projection in the plane p on the optical axis 4 of the connecting portion 5c). This proportionality factor may be comprised between 0.02 and 0.03. Preferably, the proportionality factor may be equal to 0.025.

According to an advantageous example, the upper portion 5a and the lower portion 5b are positioned orthogonally with respect to the optical axis 4.

Preferably, the first entrance face 5 has, in the plane p, a profile describing a sigmoid function.

More specifically, the first entrance face 5 describes a sigmoid function in which the ordinate axis and the abscissa axis are inverted. The sigmoid function (in the frame of reference (xOy)) representing the first entrance face 5 thus undergoes a rotation in the trigonometric sense by a value of 90°. A sigmoid function is defined by the equation: f(x)=1/(1+exp(−x)) Preferably, the exit face 7 comprises a first upper part 7a, a central part 7b and a first lower part 7c.

Preferably, the intersection between the first upper part 7a and the plane p forms a curved line referred to as the “first curvature 7ac”. Advantageously, the intersection between the central part 7b and the plane p forms a curved line referred to as the “fifth curvature 7bc”. Preferably, the intersection between the first lower part 7c and the plane p forms a curved line referred to as the “second curvature 7cc”.

Advantageously, the projection lens 3 comprises a second entrance face 8 comprising a second upper part 8a and a second lower part 8b. According to one possibility, the intersection between the second upper part 8a and the plane p forms a curved line referred to as the “third curvature 8ac”. Advantageously, the intersection between the second lower part 8b and the plane p forms a curved line referred to as the “fourth curvature 8bc”.

Preferably, the first curvature 7ac is more re-entrant than the fifth curvature 7bc.

Preferably, the second curvature 7cc is more re-entrant than the fifth curvature 7bc.

Advantageously, the fourth curvature 8bc is more re-entrant than the third curvature 8ac.

According to a preferred example, the luminous unit is configured to form or to participate in forming a segmented complementary high beam.

The luminous unit may comprise a secondary luminous unit configured to produce a low-beam adjunct beam. This type of beam straddles the horizon line. The lower edge of this type of beam may be juxtaposed with the horizontal line located at −0.57°. Alternatively, the lower edge of this type of beam may slightly overlap the horizontal line at −0.57° so as to obtain a good homogeneity with a low-beam near-field beam and to avoid the formation of a dark zone in a final beam formed by the superposition of the low-beam adjunct beam and of the low-beam near-field beam. In particular, the low-beam adjunct beam may form a shoulder part of the cutoff of a low beam. This shoulder part is also called the angled portion or “kink” of the “low” beam.

Beams of the low-beam type typically have a first lateral zone (normally at the edge of the roadway) that projects at a slightly greater height than in a second lateral zone (normally at the center of the roadway), these two zones following one another laterally with the presence of a bend or kink between them.

The luminous unit may comprise another secondary luminous unit configured to produce a low-beam near-field beam.

More specifically, the low-beam near-field beam corresponds to a beam that may be considered to form the base of a low beam. The low-beam near-field beam is a wide beam the highest part of which forms a horizontal upper cutoff that is located at 0° or below, for example at −0.57° below the horizon line. The low-beam near-field beam is a beam that is wide compared with a low-beam adjunct beam.

Moreover, when the low-beam adjunct beam is superposed on the low-beam near-field beam, the lower edge of the segments forming the low-beam adjunct beam may be juxtaposed with the horizontal upper cutoff of the low-beam near-field beam.

The function of a complementary high beam is to light a large extent of the scene in front of the vehicle, but also to provide lighting to a substantial distance, typically to about two-hundred meters. This beam of light, because of its lighting function, is mainly located above the horizon line. It may for example have a slightly upward sloping lighting optical axis. In particular, it may be used to generate a “complementary” lighting function that forms a portion of a high beam complementary to the portion produced by a low-beam near-field beam, the complementary high beam seeking solely, or at least mainly, to light above the horizon line, whereas the low-beam near-field beam (which may have the specificities of a low beam) seeks to light solely, or at least mainly, below the horizon line. The complementary high beam may therefore be a main part of the overall “high” beam and be associated with another beam participating in the low beam. Thus, the complementary high beam can form, in combination with a low-beam near-field beam, an overall high-beam beam. A low-beam near-field beam is typically a projection that is relatively spread out laterally in front of the vehicle, predominantly or completely below the horizon line, a good distribution of the illumination over the entire zone that is lit generally being sought.

The luminous unit may also be used for other lighting functions via or apart from those described above, in relation to adaptive beams. It is thus possible to produce a lighting matrix to selectively illuminate parts of the space in front of the vehicle.

Preferably, a luminous module for an automotive vehicle comprises a plurality of luminous units 9a, 9b, . . . , 9i. Each luminous unit 9a, 9b, . . . , 9i of the plurality of luminous units 9a, 9b, . . . , 9i comprises a separate row of light sources. The plurality of luminous units 9a, 9b, . . . , 9i is positioned in such a way that each row of light sources (of each luminous unit of the plurality of luminous units) is fastened to the same support 6. The luminous units 9a, 9b, . . . , 9i are positioned in such a way that a first luminous unit 9a, 9b, . . . , 9i and a second luminous unit 9a, 9b, . . . , 9i being adjacent to the same third luminous unit 9a, 9b, . . . , 9i are positioned in such a way that the first luminous unit 9a, 9b, . . . , 9i is positioned above the third luminous unit 9a, 9b, . . . , 9i and the second luminous unit 9a, 9b, . . . , 9i is positioned below the third luminous unit 9a, 9b, . . . , 9i.

Thus, due to this configuration, the luminous units making up the luminous module are offset in the vertical direction and also in the horizontal direction.

Thus, the fact that each luminous unit is configured to form or to participate in forming a segmented complementary high beam implies that the luminous module makes it possible to form or participate in forming a segmented complementary high beam made up of all the segmented complementary high beams of each luminous unit making up the luminous module. All the segmented complementary high beams of each luminous unit making up the luminous module are partially superposed in such a way that the resulting luminous intensity is greater and also that the lighting has a greater extent (notably in height) than if the luminous module were made up of a single luminous unit. Given that the row 1 of light sources of each luminous unit making up the luminous module is individually activatable (with respect to the other rows 1 of light sources of the luminous module) and the light sources of each row 1 of light sources are individually activatable, the luminous module makes it possible to produce lighting made up of a plurality of juxtaposed luminous segments that can be selectively activated.

The luminous module may be made up of 5 luminous units. Thus, in the case where the row 1 of light sources of each luminous unit comprises 5 light sources, the luminous module comprises 25 light sources.

The luminous module may have a height of 80 mm measured along an axis parallel to the direction in which the support 6 is inclined. Notably, when the luminous module comprises 5 luminous units, the luminous module may have a height of 80 mm measured along an axis parallel to the direction in which the support 6 is inclined.

Advantageously, the light sources of the row 1 of light sources of each of the luminous units (9a, 9b, . . . , 9i) are moved in translation in the first direction d1 with respect to the light sources of the other rows of light sources of all the luminous units. Preferably, the translational movement in question may be equal to one sixth of a spacing between two consecutive light sources of the same row of light sources.

The spacing between two consecutive light sources is measured between the center of one of the two light sources and the center of the other light source.

Thus, in the case where five luminous units make up the luminous module, the value of the translational movement of one sixth of the spacing between two consecutive light sources of the same row of light sources makes it possible to obtain homogeneous lighting in a direction parallel to the first direction d1 and therefore to eliminate dark zones that may appear between the projections of the segments resulting from the switching on of a group of light sources from the row of light sources.

One or more luminous modules according to the invention may be arranged in a housing closed by an outer lens so as to obtain one or more lighting and/or signaling beams at the exit of the headlamp. A headlamp may also be complex and comprise a plurality of modules that may, furthermore, optionally share components.

The invention is not limited to the embodiments described above and extends to all the embodiments covered by the invention.

### LIST OF REFERENCES

1. row of light sources
1a. light rays
2. primary lens
3. projection lens
4. optical axis
5. first entrance face
5a. upper portion
5b. lower portion
5c. connecting portion
6. support
7. exit face
7a. first upper part
7ac. first curvature
7b. central part
7bc. fifth curvature
7c. first lower part
7cc. second curvature
8. second entrance face
8a. second upper part
8ac. third curvature
8b. second lower part
8bc. fourth curvature
9a, 9b, . . . , 9i. plurality of luminous units
10. optical system
d2. second direction
d1. first direction
F. main object focal point
DF. focal length
p. plane
α. angle

What is claimed is:

1. A luminous unit for an automotive vehicle, comprising:
a row of light sources emitting light rays, the row of light sources including light sources aligned in a first direction, each light source of the row of light sources being individually activatable,
a support on which the row of light sources is disposed, and
an optical system including:
a primary lens including an optical axis, a first entrance face and an exit face, and
a projection lens, the light rays passing first through the primary lens and second through the projection lens,
wherein a plane is perpendicular to the first direction and includes the optical axis, and
wherein the support forms with the optical axis an angle different from 90°, and in that the first entrance face includes a planar upper portion, a planar lower portion and a connecting portion, the lower portion being offset relative to the upper portion along the optical axis, the upper portion and the lower portion being connected by the connecting portion.

2. The luminous unit as claimed in claim 1, wherein the first entrance face receives the light rays emitted by the row of light sources.

3. The luminous unit as claimed in claim 1, wherein the upper portion is offset along the optical axis, relative to the lower portion, in order to be closer to the exit face.

4. The luminous unit as claimed in claim 1, wherein the upper portion is offset along the optical axis, relative to the lower portion, in order to be farther away from the exit face.

5. The luminous unit as claimed in claim 1, wherein the support is inclined with respect to the optical axis so that the light rays are oriented more toward the upper portion than toward the lower portion.

6. The luminous unit as claimed in claim 1, wherein the optical system has a main object focal point, the light sources of the row of light sources being positioned with respect to the optical axis so that, in the plane, the light sources orthogonal projection on the optical axis intercepts the optical axis at the main object focal point.

7. The luminous unit as claimed in claim 1, wherein the row of light sources is traversed by the optical axis.

8. The luminous unit as claimed in claim 7, wherein the angle is greater than 90° and lower than or equal to 120°, and the connecting portion is traversed by the optical axis.

9. The luminous unit as claimed in claim 7, wherein the angle is greater than 120° and lower than or equal to 135°, and the connecting portion is offset with respect to the optical axis so as to reduce the size of the upper portion.

10. The luminous unit as claimed in claim 1, wherein the optical system has a focal length, the length of the orthogonal projection in the plane on the optical axis of the connecting portion being proportional to the focal length by applying a proportionality factor between 0.02 and 0.03.

11. The luminous unit as claimed in claim 1, wherein the upper portion and the lower portion are perpendicular to the optical axis.

12. The luminous unit as claimed in claim 1, wherein the exit face includes a first upper part having a first curvature along the plane, a central part having a fifth curvature along the plane and a first lower part having a second curvature along the plane, and wherein the projection lens includes a second entrance face including a second upper part having a third curvature along the plane and a second lower part having a fourth curvature along the plane plane, the first curvature being more convex than the fifth curvature and/or the second curvature being more convex than the fifth curvature and/or the fourth curvature being more convex than the third curvature.

13. The luminous unit as claimed in claim 1, wherein the luminous unit is configured to form or to participate in forming a segmented complementary high beam.

14. A luminous module for an automotive vehicle, comprising a plurality of luminous units, the luminous units including a row of light sources emitting light rays, the row of light sources including light sources aligned in a first direction, each light source of the row of light sources being individually activatable, a support on which the row of light sources is disposed, and an optical system including a primary lens including an optical axis, a first entrance face and an exit face, and a projection lens, the light rays passing first through the primary lens and second through the projection lens, wherein a plane is perpendicular to the first direction and includes the optical axis, and wherein the support forms with the optical axis an angle different from 90°, and in that the first entrance face includes a planar upper portion, a planar lower portion and a connecting portion, the lower portion being offset relative to the upper portion along the optical axis, the upper portion and the lower portion being connected by the connecting portion, the luminous unit being superposed in a second direction, the luminous units sharing the same support, the second direction being perpendicular to the optical axis and to the first direction.

15. The luminous module as claimed in claim 14, wherein the light sources of the row of light sources of each of the luminous units are offset, in the first direction, relative to the light sources of the rows of light sources of all the other luminous units.
